(19) United States
(12) Patent Application Publication
(10) Pub. No.: US 2022/0237453 A1
(43) Pub. Date: Jul. 28, 2022

(54) CONVOLUTIONAL HIERARCHICAL TEMPORAL MEMORY SYSTEM AND METHOD

(71) Applicant: SONASOFT CORPORATION, San Jose, CA (US)

(72) Inventors: Teja Veeramacheneni, Fremont, CA (US); Max Lee, Bountiful, UT (US)

(21) Appl. No.: 17/582,843

(22) Filed: Jan. 24, 2022

Related U.S. Application Data
(60) Provisional application No. 63/142,092, filed on Jan. 27, 2021.

(51) Int. Cl. G06N 3/08; G06N 3/04

(52) U.S. Cl. CPC G06N 3/08; G06N 3/04

(57) ABSTRACT

A data processing system includes (i) a convolutional neural network trained on an input dataset, and (ii) a hierarchical temporal memory system. The convolutional neural network generates a plurality of extracted layers. The hierarchical temporal memory system generates an output dataset from the plurality of extracted layers generated by the convolutional neural network. The plurality of extracted layers can include a convolution layer that extracts data from the input dataset and/or a rectifier that introduces non-linearity to the convolutional neural network. The plurality of extracted layers can include a batch normalizer that normalizes the data from the input dataset and/or a dropout that increases sparsity and prevents overfitting of the convolutional neural network. The hierarchical temporal memory system can binarize the output dataset. The hierarchical temporal memory system can include a hierarchical temporal memory pattern classifier that classifies patterns within the output dataset. The plurality of extracted layers can include a plurality of weights of the convolutional neural network.

### RELATED APPLICATION

This application claims priority from U.S. Provisional Application Ser. No. 63/142,092, filed on Jan. 26, 2021. To the extent permitted, the contents of U.S. Provisional Application Ser. No. 63/142,092 are incorporated in their entirety herein by reference.

### BACKGROUND

Convolution neural networks (CNNs) can be trained to perform various tasks on different types of data. For example, CNNs can be trained to receive data related to documents and can be trained to perform document classification. As another example, CNNs can be trained to perform computer-implemented visual object classification, which is also called object recognition. Object recognition pertains to the classifying of visual representations of real-life objects found in still images or motion videos captured by a camera. By performing visual object classification, each visual object found in the still images or motion video is classified according to its type (such as, for example, human, vehicle, or animal). A convolutional neural network (CNN) can be trained to perform any task. The CNN can include a group of layers connected in series with a group of layers and can be configured such that data for the CNN is input to the group of layers. The CNN can include any number of layers so that the CNN can perform any number of tasks.

Hierarchical temporal memory (HTM) systems represent another approach to machine intelligence. In HTM systems, training data comprising temporal sequences of patterns are presented to a network of nodes. The HTM systems then build a model of the statistical structure inherent to the patterns and sequences in the training data, and thereby learns the underlying causes of the temporal sequences of patterns and sequences in the training data. The hierarchical structure of the HTM systems allows them to build models of very high dimensional input spaces using reasonable amounts of memory and processing capacity. Currently, HTM models (especially in regards to image classification) do not have great accuracy. Previous experiments using HTM models have been able to obtain around 95% accuracy on the MNIST dataset. However, state of the art CNNs can obtain 99.7% accuracy on the MNIST dataset. Generally speaking, CNNs outperform HTMs for most tasks. Unfortunately, state of the art CNNs require tens of millions of parameters, which can be impractical either in terms of cost, storage, and/or memory.

### SUMMARY

The present invention is directed toward a data processing system. In various embodiments, the data processing includes a convolutional neural network trained on an input dataset and a hierarchical temporal memory system. The convolutional neural network can be configured to generate a plurality of extracted layers. The hierarchical temporal memory system can generate an output dataset from the plurality of extracted layers generated by the convolutional neural network

In certain embodiments, the plurality of extracted layers can include a convolution layer that extracts data from the input dataset.

In various embodiments, the plurality of extracted layers can include a rectifier that introduces non-linearity to the convolutional neural network.

In some embodiments, the plurality of extracted layers can include a batch normalizer that normalizes the data from the input dataset.

In certain embodiments, the plurality of extracted layers can include a dropout that increases sparsity and prevents overfitting of the convolutional neural network.

In various embodiments, the hierarchical temporal memory system can binarize the output dataset.

In some embodiments, the hierarchical temporal memory system can include a hierarchical temporal memory pattern classifier that classifies patterns within the output dataset.

In certain embodiments, the plurality of extracted layers can include a plurality of weights of the convolutional neural network.

In various embodiments, the input data set can include an input image.

In some embodiments, the hierarchical temporal memory system can be trained by analyzing an input image from a training dataset.

In certain embodiments, the output dataset is a training model.

The present invention is also directed toward a method for data processing that implements any of the data processing systems shown and/or described herein.

The present invention is further directed toward a method for data processing.

In various embodiments, the method can include the steps of training a convolutional neural network on an input dataset and generating a plurality of extracted layers from the convolutional neural network.

In some embodiments, the method can also include the step of utilizing the plurality of extracted layers within a hierarchical temporal memory system to generate an output dataset.

In certain embodiments, the plurality of extracted layers can include a convolution layer that extracts data from the input dataset.

In various embodiments, the plurality of extracted layers can include a rectifier that introduces non-linearity to the convolutional neural network.

In some embodiments, the plurality of extracted layers can include a batch normalizer that normalizes the data from the input dataset.

In certain embodiments, the plurality of extracted layers can include a dropout that increases sparsity and prevents overfitting of the convolutional neural network.

In various embodiments, the hierarchical temporal memory system can binarize the output dataset.

In some embodiments, the hierarchical temporal memory system can include a hierarchical temporal memory pattern classifier that classifies patterns within the output dataset.

In certain embodiments, the plurality of extracted layers can include a plurality of weights of the convolutional neural network.

In various embodiments, the input data set can include an input image.

In some embodiments, the hierarchical temporal memory system can be trained by analyzing an input image from a training dataset.

In certain embodiments, the output dataset is a training model.

The present invention is also directed toward a system that implements any of the methods for data processing that are shown and/or described herein.

The present invention is further directed toward a data processing system. In various embodiments, the data processing includes a convolutional neural network trained on an input dataset and a hierarchical temporal memory system. The convolutional neural network can be configured to generate a plurality of extracted layers. The plurality of extracted layers can include only a convolutional layer and a batch normalization layer. The hierarchical temporal memory system can generate an output dataset from the plurality of extracted layers generated by the convolutional neural network. The hierarchical temporal memory system can include a hierarchical temporal memory pattern classifier. The hierarchical temporal memory pattern can be configured to make predictive classifications after being trained on the plurality of extracted layers.

The present invention is also directed toward a method for data processing. The method for data processing can include the steps of training a convolutional neural network on an input dataset and generating a plurality of extracted layers from the convolutional neural network. The plurality of extracted layers can include only a convolutional layer and a batch normalization layer. The method can further include the step of training a hierarchical temporal memory system on the output dataset from the plurality of extracted layers. In various embodiments, the method can include the step of making predictive classifications using the temporal memory pattern classifier.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram depicting one embodiment of a data processing system having features of the present invention;

FIG. 2 is a block diagram depicting one embodiment of a convolution neural network for use within the data processing system;

FIG. 3 is a block diagram depicting one embodiment of a hierarchical temporal memory system for use within the data processing system; and

FIG. 4 is a flow chart depicting one embodiment of a method for data processing having steps of the present invention.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of convolutional hierarchical temporal memory models. In particular, the present invention can extract trained convolutional and batch normalization layers as an input for a hierarchical temporal memory (HTM) model. With this approach, the accuracy of the HTM model can be improved at a greater efficiency than a convolutional neural network while using fewer weights. The present invention can be implemented on devices with limited storage, in sharp contrast to many convolutional neural networks. In some embodiments, the present invention can be trained and used as a visual object classifier. By using the systems and methods described herein, the present invention can be trained to make accurate, predictive classifications of input images.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is appreciated that such a development effort might be complex and time-consuming, but would nevertheless be a routine undertaking of engineering for those of ordinary skill in the art having the benefit of this disclosure.

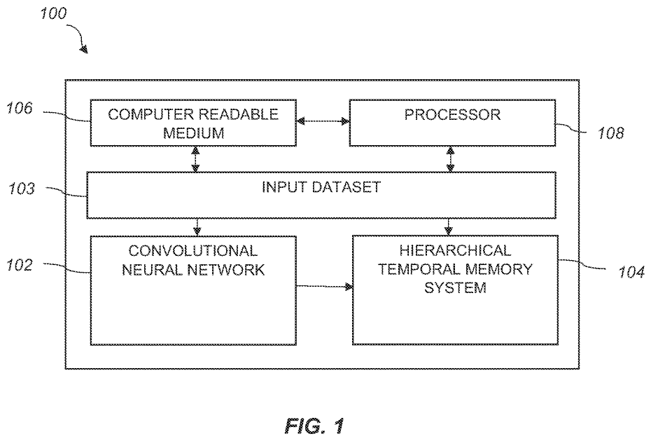

FIG. 1 is a block diagram depicting one embodiment of a data processing system 100. The data processing system 100 is suitable for processing data, performing tasks, training, developing artificial intelligence networks and models, and/or visual object classification. The data processing system 100 can vary depending on the design requirements of the data processing system 100. It is understood that the data processing system 100 can include additional systems, subsystems, components, and elements than those specifically shown and/or described herein. Additionally, or alternatively, the data processing system 100 can omit one or more of the systems, subsystems, and elements that are specifically shown and/or described herein. In the embodiment illustrated in FIG. 1, the data processing network 100 can include a convolutional neural network 102, an input dataset 103, a hierarchical temporal memory system 104, a non-transitory computer-readable medium 106, and a processor 108.

The convolutional neural network 102 (also sometimes referred to herein as “CNN”) can be trained to perform different tasks on various types of data. For example, the CNN 102 can be trained to receive data related to documents and can be trained to perform document classification. As another example, the CNN 102 can be trained to perform computer-implemented visual object classification. The CNN 102 can vary depending on the design requirements of the data processing system 100 and/or the hierarchical temporal memory system 104. It is understood that the CNN 102 can include additional systems, subsystems, components, and elements than those specifically shown and/or described herein. Additionally, or alternatively, the CNN 102 can omit one or more of the systems, subsystems, and elements that are specifically shown and/or described herein.

The CNN 102 can include a plurality of layers, including a first group of layers connected in series with a second group of layers, and is configured such that data for the CNN 102 is input into the first group of layers, transformed by the first group of layers, then sent to the second group of layers. It is appreciated that the CNN 102 can include any number of layers and/or groups of layers. After the data is transformed by the groups of layers, the transformed data is output from the CNN 102. In other embodiments, the CNN 102 can use any suitable data.

The data for the CNN 102 can include a first image or any number of images. The CNN 102 can be configured to receive the first image as part of a first batch of image data. In other embodiments, the CNN can be configured to receive any number of batches including any number of images. The first batch of image data can include a four-dimensional data structure. The CNN 102 can be configured such that the first group of layers processes the first image and a second image, the second group of layers receives the first image after the first image has been processed by the first group of layers. The CNN 102 can be configured to perform a first task comprising generating a feature vector identifying a first type of object depicted in the first image.

The input dataset 103 includes data, a dataset, and/or a database that can be processed in the data processing system by the CNN 102 and/or the hierarchical temporal memory system 104. The input dataset 103 can be any viable data, a dataset, or a database usable by the data processing system 100. The CNN 102 can be trained on the input dataset 103, including any image-based dataset. The input dataset 103 can vary depending on the design requirements of the data processing system 100, the CNN 102, and/or the hierarchical temporal memory system 104. It is understood that the input dataset 103 can include additional data, datasets, databases, and elements than those specifically shown and/or described herein. Additionally, or alternatively, the input dataset 103 can omit one or more of the systems, subsystems, and elements that are specifically shown and/or described herein.

In some embodiments, the input dataset 103 can be a dataset specifically configured for machine learning, machine learning research, and machine learning training. In one embodiment, the input dataset 103 used by the data processing system 100 can be the Modified National Institute of Standards and Technology database (also sometimes referred to herein as “MNIST database”). In various embodiments, the MNIST database is a database of handwritten digits and includes a training set of 60,000 examples and a test set of 10,000 examples. The digits in the MINIST database can be size-normalized and centered in a fixed-size image. In other embodiments, the input dataset 103 used by the data processing system 100 can be the Microsoft® COCO: Common Objects in Context database (also sometimes referred to herein as “MS-COCO”).

The hierarchical temporal memory system 104 (also sometimes referred to herein as “HTM system”) can be trained to perform various tasks on different types of data. For example, the HTM system 104 can include temporal sequences of patterns that are presented to a network of nodes. In various embodiments, the HTM system 104 can then build a model of the statistical structure inherent to the patterns and sequences in the training data, and thereby learns the underlying causes of the temporal sequences of patterns and sequences in the training data. The hierarchical structure of the HTM systems allows them to build models of very high dimensional input spaces using reasonable amounts of memory and processing capacity. As another example, the HTM system 104 can be trained to perform computer-implemented visual object classification.

The HTM system 104 can vary depending on the design requirements of the data processing system 100 and/or the CNN 102. It is understood that the HTM system 104 can include additional systems, subsystems, components, and elements than those specifically shown and/or described herein. Additionally, or alternatively, the HTM system 104 can omit one or more of the systems, subsystems, and elements that are specifically shown and/or described herein.

The non-transitory computer-readable medium 106 can store computer program instructions. The non-transitory computer-readable medium 106 can vary depending on the design requirements of the data processing system 100, the CNN 102, the input dataset 103, the HTM system 104, and/or the processor 108. It is understood that the non-transitory computer-readable medium 106 can include additional systems, subsystems, components, and elements than those specifically shown and/or described herein. Additionally, or alternatively, the non-transitory computer-readable medium 106 can omit one or more of the systems, subsystems, and elements that are specifically shown and/or described herein.

The non-transitory computer-readable medium 106 can be a tangible computer-readable carrier, such as a magnetic or optical memory or a magnetic or optical disk, as non-exclusive, non-limiting examples. The input dataset 103 can be stored on the non-transitory computer-readable medium 106. The non-transitory computer-readable medium 106 can include any number of computer units, processors, systems, devices, and/or components necessary to perform the functions of the CNN 102, the HTM system 104, and/or the processor 108 within the data processing system 100.

The processor 108 can process a number of operations, including executing code. The processor 108 can control, facilitate, and/or administrate all of the functions within the data processing system 100. The processor 108 can vary depending on the design requirements of the data processing system 100. It is understood that processor 108 can include additional systems, subsystems, components, and elements than those specifically shown and/or described herein. Additionally, or alternatively, the processor 108 can omit one or more of the systems, subsystems, and elements that are specifically shown and/or described herein. One or more processors 108 can be used in the communication system. The processor 108 can work in cooperation with the non-transitory computer-readable medium 106 to input the input dataset 103 into the CNN 102 and/or the HTM system 104.

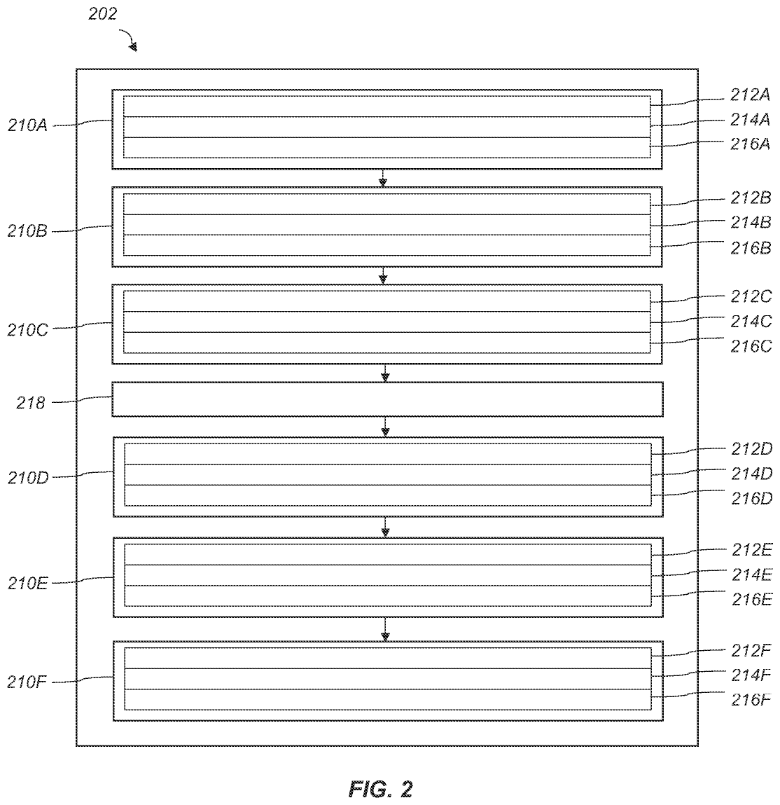

FIG. 2 is a block diagram depicting one embodiment of the convolution neural network 202 (also sometimes referred to herein as “CNN”) for use within the data processing system 100 (illustrated in FIG. 1). The CNN 202 can be trained to perform various tasks on various types of data. In one representative embodiment, illustrated in FIG. 2, the CNN 202 can include a first group of layers 210A, a second group of layers 210B, a third group of layers 210C, a fourth group of layers 210D, a fifth group of layers 210E, a sixth group of layers 210F, and a dropout 218. It is appreciated that although the CNN 202 illustrated in FIG. 2 includes six groups of layers, the CNN 202 can include any suitable number of groups of layers greater or fewer than six. Further, although the CNN 202 illustrated in FIG. 2 includes one dropout 218, it is understood that any suitable number of dropouts can be included in the CNN 202. One or more elements of the CNN 202, including the groups of layers and the dropout(s), can include weights, as described in greater detail herein.

The first group of layers 210A can include any number of layers. In the embodiment illustrated in FIG. 2, the first group of layers 210A can include one or more of a convolutional layer 212A, a rectified linear unit 214A, and/or a batch normalization layer 216A. Somewhat similarly, the second group of layers 210B can include one or more of a convolutional layer 2128, a rectified linear unit 2148, and/or a batch normalization layer 2168. Somewhat similarly, the third group of layers 210C, the fourth group of layers 210D, the fifth group of layers 210E, and the sixth group of layers 210F can include the same and/or a similar composition of layers as the first group of layers 210A and/or the second group of layers 210B. Stated another way, one or more of the groups of layers 210A-F can include convolution layers 212A-F, rectified linear units 214A-F, and/or batch normalization layers 216A-F. Alternatively, one or more of the groups of layers 210A-F can include other suitable types of layers.

In various embodiments, the convolutional layers 212A-F can be used to extract features from an input image from the input dataset 103. The convolutional layers 212A-F can have parameters that can include any number of learnable filters to extract any number of features from the input image (including, but not limited to edges, corners, shapes, patterns, etc.). Each filter can be convolved across some or all of the width and the height of the input image. The filter can detect a specific type of feature (or features) from the input image.

In certain embodiments, the rectified linear units 214A-F can have a non-linear function configured to introduce non-linearity into the CNN 202 and to increase complexity within the network. The rectified linear units 214A-F can apply a non-saturating activation function and can remove negative values from an activation map by setting them to zero. The rectified linear units 214A-F can increase the nonlinear properties of a decision function and the CNN 202 without affecting the receptive fields of the convolution layers 212A-F.

In various embodiments, the batch normalization layers 216A-F can include batch normalization that can normalize the data within the first group of layers 210A and/or the CNN 202. The batch normalization layers 216A-F can normalize any data in the CNN 202. In one non-exclusive example, the batch normalization layers 216A-F can normalize the input data (e.g., the input image) by re-centering and re-scaling the input data.

The dropout 218 is configured to increase sparsity and prevent overfitting of the CNN 202. The dropout 218 can remove some or all of a row in the vector-matrix and can remove random weights.

In certain embodiments, the convolution layers 212A-F can include weights (not shown). In the convolution layers 212A-F, for example, the weights can be represented as the multiplicative factor of the convolution filters. Still further, in various embodiments, the weights can be extracted from the individual layers and/or groups of layers. In some embodiments, the CNN 202 can include additional layers and/or groups of layers, including linear layers and/or groups of linear layers. The CNN 202 can include duplicative layers and/or groups of layers.

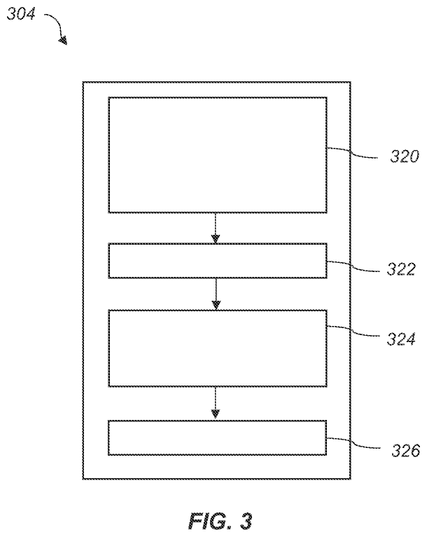

FIG. 3 is a block diagram depicting one embodiment of an HTM system 304 for use within the data processing system 100. The HTM system 304 can be trained to perform various tasks on various types of data. In the embodiment illustrated in FIG. 3, the HTM system 304 can include a group of extracted CNN layers 320, a binarizer 322, a hierarchical temporal memory classifier 324 (also sometimes referred to herein as “HTM classifier”), and an output dataset 326. The HTM system 304 can be trained using the input dataset 103 or any viable input dataset. It is appreciated that the HTM system 304 can include any number of elements and/or components.

The extracted CNN layers 320 can be extracted from the CNN 202 and imported into the HTM system 304. The input data (e.g., an input image) from the input dataset 103 can be inserted into the extracted CNN layers 320 to output data (e.g., an output image). The extracted CNN layers 320 can include the layers and/or groups of layers illustrated in FIG. 2 as 202A through 202G. The extracted CNN layers 320 can include additional layers and/or groups of layers than those illustrated in FIG. 2. The extracted CNN layers 320 can omit any of the layers and/or groups of layers illustrated in FIG. 2. The extracted CNN layers 320 can include any suitable layers and/or groups of layers configured for use within the HTM system 304. The weights from the extracted CNN layers 320 can be exported from the CNN 202.

The binarizer 322 can transform the output data (e.g., the output image) from the extracted CNN layers 320 into binary values based on a threshold. The binarizer 322 can also transform the output data features into vectors of binary numbers.

The HTM classifier 324 can be configured to classify the binarized output data. The HTM classifier 324 can include any number of algorithms that can store, learn, infer, and recall sequences/patterns based on the data that is input into the HTM classifier 304C. The HTM classifier 324 can be used to train the HTM system 304 and/or output an output dataset 326 (e.g., a prediction/classification) of any inserted input data.

The output dataset 326 can take any viable form. In various embodiments, the output dataset 326 can include a prediction and/or a classification based on the data classified by the HTM classifier 304C. The output dataset 326 can also take the form of a training dataset for use by the HTM system 304 and/or other artificial intelligence systems configured to perform visual object classification.

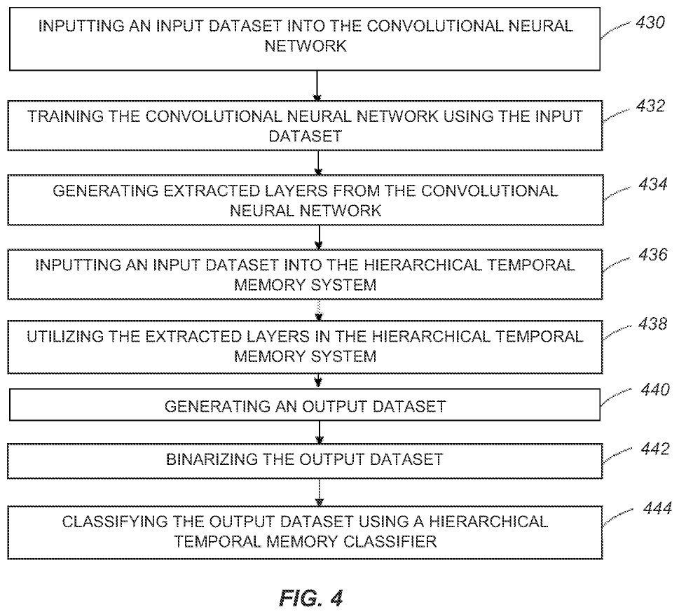

FIG. 4 is a flow chart depicting one embodiment of a method for data processing which can include one or more of the following steps provided herein. It is understood that the method can include additional steps than those specifically shown and/or described herein. Additionally, or alternatively, the method can omit one or more of the steps that are specifically shown and/or described herein. The method for data processing can be implemented on the data processing system 100 (illustrated in FIG. 1), or other systems and subsystems not specifically shown and/or described herein. It is understood that the method shown and/or described herein can be controlled by the processor 108 (illustrated in FIG. 1) or other components of the data processing system 100. In other words, the method can be enabled by the data processing system 100 via the processor 108.

At step 430, an input dataset can be input into the CNN 102 (illustrated in FIG. 1). The input dataset 103 (illustrated in FIG. 1) can include one or more of data, a dataset, or a database that can be processed in the data processing system 100 by the CNN 102 and/or the hierarchical temporal memory system 104 (illustrated in FIG. 1). The input dataset 103 can include any viable data, a dataset, and/or a database usable by the data processing system 100.

At step 432, the CNN 102 can be trained using the input dataset 103. The CNN 102 can be trained on any viable dataset, including the image-based datasets described herein.

At step 434, the CNN 102 can generate extracted layers. The extracted layers can include one or more of the groups of layers 210A-F (illustrated in FIG. 2).

At step 436, the input dataset 103 can be input into the HTM system 104. The input dataset 103 can include one or more of data, a dataset, and/or a database that can be processed in the data processing system 100 by the CNN 102 and/or the HTM system 104. The input dataset 103 can include one or more of any viable data, a dataset, and/or a database usable by the data processing system 100. The input dataset 103 can include the same as the input dataset 103 used in step 430.

At step 438, the generated extracted layers from the CNN 102 are utilized by the hierarchical temporal memory system 104. In particular, the input dataset 103 can be run through the extracted layers and/or groups of layers.

At step 440, an output dataset is generated by running the input dataset 103 through the extracted layers. The input data (e.g., an input image, in one non-exclusive embodiment) from the input dataset 103 can be inserted into the extracted CNN layers 320 to output the output data (e.g., an output image).

At step 442, the output dataset is binarized. The binarizer 322 (illustrated in FIG. 3) can transform the output data (e.g., the output image) from the extracted CNN layers 320 (illustrated in FIG. 3) into binary values based on a threshold. The binarizer 322 can also transform the output data features into vectors of binary numbers.

At step 444, the binarized output dataset is classified using an HTM classifier 304C (illustrated in FIG. 3). The HTM classifier 324 (illustrated in FIG. 3) can include any number of algorithms that can store, learn, infer, and/or recall sequences/patterns based on the data that is input into the HTM classifier 304C. The HTM classifier 324 can be used to train the HTM system 304 (illustrated in FIG. 3, for example) and/or output an output dataset 326 (illustrated in FIG. 3), e.g., a prediction/classification of any inserted input data.

The systems and methods described herein can improve the classification accuracy (in particular, image classification) of HTM models. The hybrid convolutional hierarchical temporal memory systems and methods provided herein remedy the accuracy issues of HTMs and the efficiency issues of CNNs, while achieving an accuracy rate of about 97% on image classification tasks. The hybrid convolutional hierarchical temporal memory systems and methods provided herein can use around 2% of the parameters of CNNs and can intentionally omit the first linear layer (and the other CNN linear layers) from the group of extracted layers. In contrast, the first linear layer (and the other CNN linear layers) is typically included in CNNs. The linear layer is deeply connected and can receive all inputs from the previous convolutional layer. The hybrid convolutional hierarchical temporal memory systems and methods provided herein can be implemented on devices with limited storage.

Systems, methods, and computer program products are provided. In the detailed description herein, references to “various embodiments”, “one embodiment”, “an embodiment”, “an example embodiment”, “certain embodiments”, “some embodiments”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein can be implemented using the below particular machines, and those hereinafter developed, in any suitable combination, as would be appreciated immediately by one skilled in the art. Further, as is unambiguous from this disclosure, the methods described herein can result in various transformations of certain articles.

For the sake of brevity, conventional data networking, application development, and other functional aspects of the systems (and components of the individual operating components of the systems) are not be described in detail herein. Furthermore, the connecting lines shown in the various figures contained herein are intended to represent exemplary functional relationships and/or physical couplings between the various elements. It should be noted that many alternative or additional functional relationships or physical connections can be present in a practical system.

The present system or any part(s) or function(s) thereof can be implemented using hardware, software, or a combination thereof and can be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations can be machine operations. Useful machines for performing the various embodiments include general-purpose digital computers or similar devices.

In fact, in various embodiments, the embodiments are directed toward one or more computer systems capable of carrying out the functionality described herein. The computer system includes one or more processors, such as a processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random-access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage unit in a well-known manner. The removable storage unit represents a floppy disk, magnetic tape, optical disk, etc. which is read by and written to by removable storage drive. As will be appreciated, the removable storage unit includes a computer-usable storage medium having stored therein computer software and/or data.

In various embodiments, secondary memory can include other similar devices for allowing computer programs or other instructions to be loaded into the computer system. Such devices can include, for example, a removable storage unit and an interface. Examples of such can include a program cartridge and cartridge interface (such as that found in video game devices), a removable memory chip (such as an erasable programmable read-only memory (EPROM), or programmable read-only memory (PROM)) and associated socket, and other removable storage units and interfaces, which allow software and data to be transferred from the removable storage unit to computer system.

The computer system can also include a communications interface. The communications interface allows software and data to be transferred between the computer system and external devices. Examples of communications interface can include a modem, a network interface (such as an Ethernet card), a communications port, a Personal Computer Memory Card International Association (PCMCIA) slot and card, etc. Software and data transferred via communications interface are in the form of signals which can be electronic, electromagnetic, optical, or other signals capable of being received by the communications interface. These signals are provided to the communications interface via a communications path (e.g., channel). This channel carries signals and can be implemented using wire, cable, fiber optics, a telephone line, a cellular link, a radio frequency (RF) link, wireless, and other communications channels.

The terms “computer program medium” and “computer usable medium” and “computer-readable medium” are used to generally refer to media such as removable storage drive and a hard disk installed in a hard disk drive. These computer program products provide software to the computer system.

Computer programs (also referred to as computer control logic) are stored in main memory and/or secondary memory. Computer programs can also be received via the communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, the software can be stored in a computer program product and loaded into a computer system using a removable storage drive, hard disk drive, or communications interface. The control logic (software), when executed by the processor, causes the processor to perform the functions of various embodiments as described herein. In various embodiments, hardware components such as application-specific integrated circuits (ASICs). Implementation of the hardware state machine to perform the functions described herein will be apparent to persons skilled in the relevant art(s).

In various embodiments, a server can include application servers (e.g., WEB SPHERE, WEB LOGIC, JBOSS). In various embodiments, the server can include web servers (e.g. APACHE, IIS, GWS, SUN JAVA® SYSTEM WEB SERVER).

A web client includes any device (e.g., personal computer) which communicates via any network, for example, such as those discussed herein. Such browser applications comprise Internet browsing software installed within a computing unit or a system to conduct online transactions and/or communications. These computing units or systems can take the form of a computer or set of computers, although other types of computing units or systems can be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client can run MICROSOFT® INTERNET EXPLORER®, MOZILLA® FIREFOX®, GOOGLE® CHROME®®, APPLE® Safari, or any other of the myriad software packages available for browsing the internet.

Practitioners will appreciate that a web client can or cannot be in direct contact with an application server. For example, a web client can access the services of an application server through another server and/or hardware component, which can have a direct or indirect connection to an Internet server. For example, a web client can communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client can include any suitable personal computer, network computer, workstation, personal digital assistant, cellular phone, smart phone, minicomputer, mainframe, or the like. A web client can be in a home or business environment with access to a network. In various embodiments, access is through a network or the Internet through a commercially-available web-browser software package. A web client can implement security protocols such as Secure Sockets Layer (SSL) and Transport Layer Security (TLS). A web client can implement several application layer protocols including HTTP, HTTPS, FTP, and SFTP.

In various embodiments, components, modules, and/or engines of the system can be implemented as micro-applications or micro-apps. Micro-apps are typically deployed in the context of a mobile operating system, including, for example, a WINDOWS® mobile operating system, an ANDROID® Operating System, APPLE® IOS®, a BLACKBERRY® operating system, and the like. The micro-app can be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app can leverage the communication protocol of the operating system and associated device hardware under the predetermined rules of the mobile operating system. Moreover, where the micro-app desires an input from a user, the micro-app can be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing can include location-independent computing, whereby shared servers provide resources, software, and data to computers and other devices on demand.

As used herein, “transmit” can include sending electronic data from one system component to another over a network connection. Additionally, as used herein, “data” can include encompassing information such as commands, queries, files, data for storage, and the like in digital or any other form.

Any databases discussed herein can include relational, hierarchical, graphical, or object-oriented structure and/or any other database configurations. Common database products that can be used to implement the databases include DB2 by IBM® (Armonk, N.Y.), various database products available from ORACLE) Corporation (Redwood Shores, Calif.), MICROSOFT® Access® or MICROSOFT® SQL Server, by MICROSOFT® Corporation (Redmond, Wash.), MySQL by MySQL AB (Uppsala, Sweden), or any other suitable database product. Moreover, the databases can be organized in any suitable manner, for example, as data tables or lookup tables. Each record can be a single file, a series of files, a linked series of data fields, or any other data structure. The association of certain data can be accomplished through any desired data association technique such as those known or practiced in the art. For example, the association can be accomplished either manually or automatically. Automatic association techniques can include, for example, a database search, a database merge, GREP, AGREP, SQL, using a key field in the tables to speed searches, sequential searches through all the tables and files, sorting records in the file according to a known order to simplify lookup, and/or the like. The association step can be accomplished by a database merge function, for example, using a “key field” in pre-selected databases or data sectors. Various database tuning steps are contemplated to optimize database performance. For example, frequently used files such as indexes can be placed on separate file systems to reduce In/Out (“I/O”) bottlenecks.

More particularly, a “key field” partitions the database according to the high-level class of objects defined by the key field. For example, certain types of data can be designated as a key field in a plurality of related data tables and the data tables can then be linked based on the type of data in the key field. The data corresponding to the key field in each of the linked data tables is preferably the same or of the same type. However, data tables having similar, though not identical, data in the key fields can also be linked by using AGREP, for example. In accordance with one embodiment, any suitable data storage technique can be utilized to store data without a standard format. Data sets can be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by the first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that can include fractal compression methods, image compression methods, etc.

One skilled in the art will also appreciate that, for security reasons, any databases, systems, devices, servers, or other components of the system can consist of any combination thereof at a single location or multiple locations, wherein each database or system includes any of various suitable security features, such as firewalls, access codes, encryption, decryption, compression, decompression, and/or the like.

Any of the communications, inputs, storage, databases, or displays discussed herein can be facilitated through a website having web pages. The term “web page” as it is used herein is not meant to limit the type of documents and applications that might be used to interact with the user. For example, a typical website might include, in addition to standard HTML documents, various forms, JAVA®, JAVASCRIPT, active server pages (ASP), common gateway interface scripts (CGI), extensible markup language (XML), dynamic HTML, cascading style sheets (CSS), AJAX (Asynchronous JAVASCRIPT and XML), helper applications, plug-ins, and the like. A server can include a web service that receives a request from a web server, the request including a URL and an IP address (123.56.192.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL, and UDDI. Web services methods are well known in the art and are covered in many standard texts.

Practitioners will also appreciate that there are a number of methods for displaying data within a browser-based document. Data can be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, checkboxes, option boxes, and the like.

The system and method can be described herein in terms of functional block components, screenshots, optional selections, and various processing steps. It should be appreciated that such functional blocks can be realized by any number of hardware and/or software components configured to perform the specified functions. For example, the system can employ various integrated circuit components, e.g., memory elements, processing elements, logic elements, look-up tables, and the like, which can carry out a variety of functions under the control of one or more microprocessors or other control devices. Similarly, the software elements of the system can be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python. In some embodiments, the present invention can use the PyTorch software package in Python to train the CNN and/or HTM. Visual Basic, SQL Stored Procedures, PL/SQL, any UNIX shell script, and extensible markup language (XML) with the various algorithms being implemented with any combination of data structures, objects, processes, routines, or other programming elements. Further, it should be noted that the system can employ any number of conventional techniques for data transmission, signaling, data processing, network control, and the like. Still, further, the system could be used to detect or prevent security issues with a client-side scripting language, such as JAVASCRIPT, VBScript, or the like.

These computer program instructions can be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flow and the descriptions thereof can refer to user WINDOWS®, webpages, websites, web forms, prompts, etc. Practitioners will appreciate that the illustrated steps described herein can comprise any number of configurations including the use of WINDOWS®, webpages, web forms, popup WINDOWS®, prompts, and the like. It should be further appreciated that the multiple steps as illustrated and described can be combined into single webpages and/or WINDOWS® but have been expanded for the sake of simplicity. In other cases, steps illustrated and described as single process steps can be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems and any elements that can cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone can be present in an embodiment, B alone can be present in an embodiment, C alone can be present in an embodiment, or that any combination of the elements A, B, and C can be present in a single embodiment; for example, A and B, A and C, B and C, or A and B and C.

Although the disclosure includes a method, it is contemplated that it can be embodied as computer program instructions on a tangible computer-readable carrier, such as a magnetic or optical memory or a magnetic or optical disk. All structural, chemical and functional equivalents to the elements of the above-described various embodiments that are known to those of ordinary skill in the art are expressly incorporated herein by reference and are intended to be encompassed by the present claims. Moreover, a device or method does not need to address every problem sought to be solved by the present disclosure, for it to be encompassed by the present claims. Furthermore, no element, component, or method step in the present disclosure is intended to be dedicated to the public regardless of whether the element, component or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but can include other elements not expressly listed or inherent to such process, method, article, or apparatus.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications can be made while remaining within the spirit and scope herein.

It is understood that although a number of different embodiments of the systems and methods have been illustrated and described herein, one or more features of any one embodiment can be combined with one or more features of one or more of the other embodiments, provided that such combination satisfies the intent of the present invention.

While a number of exemplary aspects and embodiments of the user interface and methods have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope, and no limitations are intended to the details of construction or design herein shown.

What is claimed is:

1. A data processing system with improved efficiency, improved accuracy, reduced processing requirements, and reduced data storage requirements for use in machine learning, the data processing system comprising:
a convolutional neural network trained on an input dataset, the convolutional neural network being configured to generate a plurality of extracted layers; and
a hierarchical temporal memory system that generates an output dataset from the plurality of extracted layers generated by the convolutional neural network.

2. The data processing system of claim 1 wherein the plurality of extracted layers includes a convolution layer that extracts data from the input dataset.

3. The data processing system of claim 1 wherein the plurality of extracted layers includes a rectifier that introduces non-linearity to the convolutional neural network.

4. The data processing system claim 1 wherein the plurality of extracted layers includes a batch normalizer that normalizes the data from the input dataset.

5. The data processing system of claim 1 wherein the plurality of extracted layers includes a dropout that increases sparsity and prevents overfitting of the convolutional neural network.

6. The data processing system of claim 1 wherein the hierarchical temporal memory system binarizes the output dataset.

7. The data processing system of claim 1 wherein the hierarchical temporal memory system includes a hierarchical temporal memory pattern classifier that classifies patterns within the output dataset.

8. The data processing system of claim 1 wherein the plurality of extracted layers includes a plurality of weights of the convolutional neural network.

9. The data processing system of claim 1 wherein the input dataset includes an input image.

10. The data processing system of claim 1 wherein the hierarchical temporal memory system is trained by analyzing an input image from a training dataset.

11. A method for data processing with improved efficiency, improved accuracy, reduced processing requirements, and reduced data storage requirements for use in machine learning, the method comprising the steps of:
training a convolutional neural network on an input dataset;
generating a plurality of extracted layers from the convolutional neural network; and
utilizing the plurality of extracted layers within a hierarchical temporal memory system to generate an output dataset.

12. The method of claim 11 wherein the plurality of extracted layers includes a convolution layer that extracts data from the input dataset.

13. The method of claim 11 wherein the plurality of extracted layers includes a rectifier that introduces non-linearity to the convolutional neural network.

14. The method of claim 11 wherein the plurality of extracted layers includes a batch normalizer that normalizes the data from the input dataset.

15. The method of claim 11 wherein the plurality of extracted layers includes a dropout that increases sparsity and prevents overfitting of the convolutional neural network.

16. The method of claim 11 wherein the hierarchical temporal memory system binarizes the output dataset.

17. The method of claim 11 wherein the hierarchical temporal memory system includes a hierarchical temporal memory pattern classifier that classifies patterns within the output dataset.

18. The method of claim 11 wherein the plurality of extracted layers includes a plurality of weights of the convolutional neural network.

19. The method of claim 11 wherein the hierarchical temporal memory system is trained by analyzing an input image from a training dataset.

20. The method of claim 11 wherein the output dataset is a training model.
